(19) United States
(12) Patent Application Publication
(10) Pub. No.: US 2012/0148004 A1
(43) Pub. Date: Jun. 14, 2012

(54) Apparatus and Method for Directional and Spectral Analysis of Neutrons

(75) Inventors: Anthony Caruso, Overland Park, KS (US); James C. Petrosky, Fairborn, OH (US); John W. McClory, Dayton, OH (US); Peter Arnold Dowben, Crete, NE (US); William Miller, Rocheport, MO (US); Thomas Oakes, Jefferson City, MO (US); Abigail Bickley, Fairborn, OH (US)

(73) Assignees: THE CURATORS OF THE UNIVERSITY OF MISSOURI, Columbia, MO (US); The Board of Regents of the University of Nebraska, Lincoln, NE (US); The United States Air Force Intellectual Property Law Division, Wright-Patterson AFB, OH (US)

(21) Appl. No.: 13/391,585

(22) PCT Filed: Aug. 20, 2010
(86) PCT No.: PCT/US2010/046188

§ 371 Date: Feb. 21, 2012

Related U.S. Application Data
(60) Provisional application No. 61/274,753, filed on Aug. 20, 2009.
(60) Provisional application No. 61/274,689, filed on Aug. 20, 2009.

(51) Int. Cl. G01T 3/08; G01T 3/00

(52) U.S. Cl. 376/154; 250/390.07; 250/370.05; 250/391

(57) ABSTRACT

A neutron detection system may include a volume of neutron moderating material, and a plurality of solid state neutron detection devices disposed within the volume of neutron moderating material, wherein some of the neutron detection devices suitable for transduction of primary reaction products resulting from a neutron interaction event, wherein some of the solid state neutron detection devices include two or more solid state neutron detection elements, and wherein the solid state neutron detection elements are configured for omnidirectional detection of impinging neutrons.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Award No. N00014-10-1-0419 awarded by the Office of Naval Research (ONR).

### CROSS-REFERENCE TO RELATED APPLICATION

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a regular (non-provisional) patent application of United States Provisional patent application entitled HIGH EFFICIENCY SOLID STATE FAST NEUTRON DETECTOR, naming Anthony N. Caruso as inventor, filed Aug. 20, 2009, Application Ser. No. 61/274,689.

For purposes of the USPTO extra-statutory requirements, the present application constitutes a regular (non-provisional) patent application of United States Provisional patent application entitled HIGH EFFICIENCY SOLID STATE NEUTRON DETECTOR AND SPECTROMETER, naming Anthony N. Caruso, James C. Petrosky, John W. McClory, and Peter Arnold Dowben as inventors, filed Aug. 20, 2009, Application Ser. No. 61/274,753.

### TECHNICAL FIELD

The present invention generally relates to a method and apparatus for neutron detection, and more particularly to a solid state based neutron detection system allowing for more efficient detection of neutrons, improved point-of-emanation determination of impinging neutrons, and enhanced spectroscopic analysis of impinging neutrons.

### BACKGROUND

Neutron detection devices have a large range of applications. In particular, neutron detection is applicable in areas such as nuclear medicine, high-energy physics, non-proliferation of nuclear materials, nuclear energy, and scientific research. Solid state devices containing neutron reactive materials, such as boron carbide or boron nitride, are capable of detecting neutrons. Commonly used neutron detectors, however, are unable to effectively analyze neutrons impinging omnidirectionally or anisotropically on a given neutron detector. Due to this limitation, commonly used neutron detectors lack in the ability to effectively determine the spatial point of emanation or energy spectrum of an incident neutron distribution having omnidirectional or anisotropcial characteristics. It is therefore desirable to have a neutron detection system that overcomes these deficiencies allowing for the accurate and efficient determination of both energy and point of emanation for omnidirectional or anisotropical incident neutrons.

### SUMMARY

A solid state neutron detection system suitable for directional and spectroscopic analysis on neutrons is disclosed. In one aspect, an apparatus for directional and spectral analysis of neutrons may include, but is not limited to, a volume of neutron moderating material, and a plurality of solid state neutron detection devices disposed within the volume of neutron moderating material, at least some of the neutron detection devices suitable for transduction of primary reaction products resulting from a neutron interaction event, wherein at least some of the solid state neutron detection elements include two or more solid state neutron detection elements and wherein the two or more solid state neutron detection elements are configured for omnidirectional detection of impinging neutrons.

In another aspect, an apparatus for directional and spectral analysis of neutrons may include, but is not limited to, a volume of neutron moderating material, and a plurality of solid state neutron detection devices disposed within the volume of neutron moderating material, at least some of the neutron detection devices suitable for transduction of primary reaction products resulting from a neutron interaction event.

In another aspect, a method for directional and spectral analysis of neutrons may include, but is not limited to, measuring a first neutron flux in a first neutron detection element of at least one solid state neutron detection system suitable for omnidirectional detection of neutrons, measuring at least one additional neutron flux in at least one additional neutron detection element of the at least one solid state neutron detection system suitable for omnidirectional detection of neutrons, the first neutron flux and the at least one additional neutron flux resulting from neutrons emanating from one or more neutron sources, and determining at least one characteristic of the neutrons emanating from the one or more neutron sources by comparing the measured first neutron flux and the measured at least one additional neutron flux to an expected neutron flux in the first neutron detection element and an expected neutron flux in the at least one additional neutron detection element for a selected set of conditions.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIG. 1A is a schematic view of a cylindrical solid state neutron detection system, in accordance with one embodiment of the present invention.

FIG. 1B is a cross-sectional view of a cylindrical solid state neutron detection system, in accordance with one embodiment of the present invention.

FIG. 1C is a schematic view of a solid state neutron detection device of a solid state neutron detection system, in accordance with one embodiment of the present invention.

FIG. 1D is a schematic view of a spherical solid state neutron detection system, in accordance with one embodiment of the present invention.

FIG. 1E is a schematic view of a spherical solid state neutron detection system, in accordance with one embodiment of the present invention.

FIG. 1F is a schematic view of a spherical solid state neutron detection system, in accordance with one embodiment of the present invention.

FIG. 1G is a schematic view of a spherical solid state neutron detection system, in accordance with one embodiment of the present invention.

FIG. 1H is a schematic view of a cylindrical solid state neutron detection system having a neutron reflector layer, in accordance with one embodiment of the present invention.

FIG. 1l is a side view of a solid state neutron detection element of a neutron detection device of a neutron detection system, in accordance with one embodiment of the present invention.

FIG. 1J is a top view of a solid state neutron detection device of a neutron detection system, in accordance with one embodiment of the present invention.

FIG. 1K is a top view of a solid state neutron detection device of a neutron detection system, in accordance with one embodiment of the present invention.

FIG. 1L is a top view of a solid state neutron detection device of a neutron detection system, in accordance with one embodiment of the present invention.

FIG. 1M is a top view of a solid state neutron detection device of a neutron detection system, in accordance with one embodiment of the present invention.

FIG. 2A through 2E is a representation of an implementation of a cylindrical neutron detection system, in accordance with one embodiment of the present invention.

FIG. 3A through 3E is a representation of an implementation of a cylindrical neutron detection system, in accordance with one embodiment of the present invention.

FIG. 4A through 4D is a representation of an implementation of a spherical neutron detection system, in accordance with one embodiment of the present invention.

FIG. 5A through 5D is a representation of an implementation of a spherical neutron detection system, in accordance with one embodiment of the present invention.

FIG. 6 depicts a high-level block diagram of an implementation of a neutron detection system, in accordance with one embodiment of the present invention.

### DETAILED DESCRIPTION OF THE INVENTION

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention. Reference will now be made in detail to the subject matter disclosed, which is illustrated in the accompanying drawings.

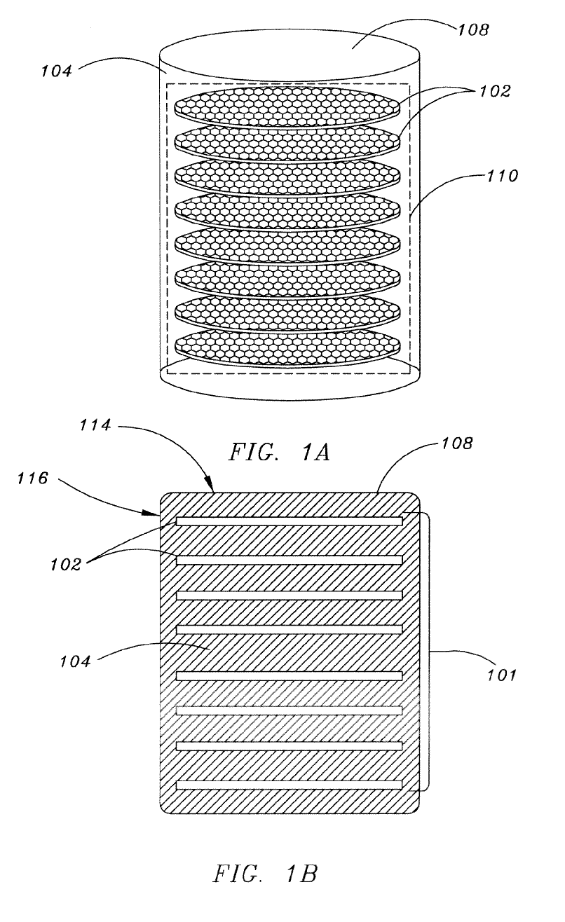

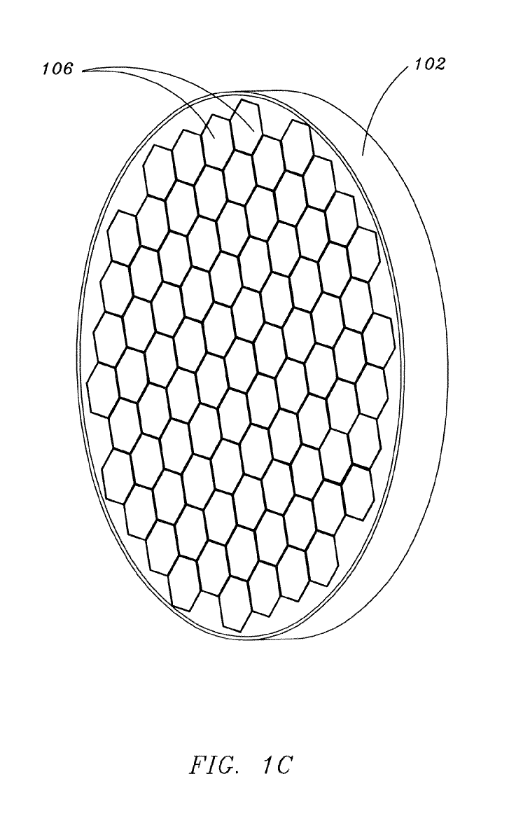

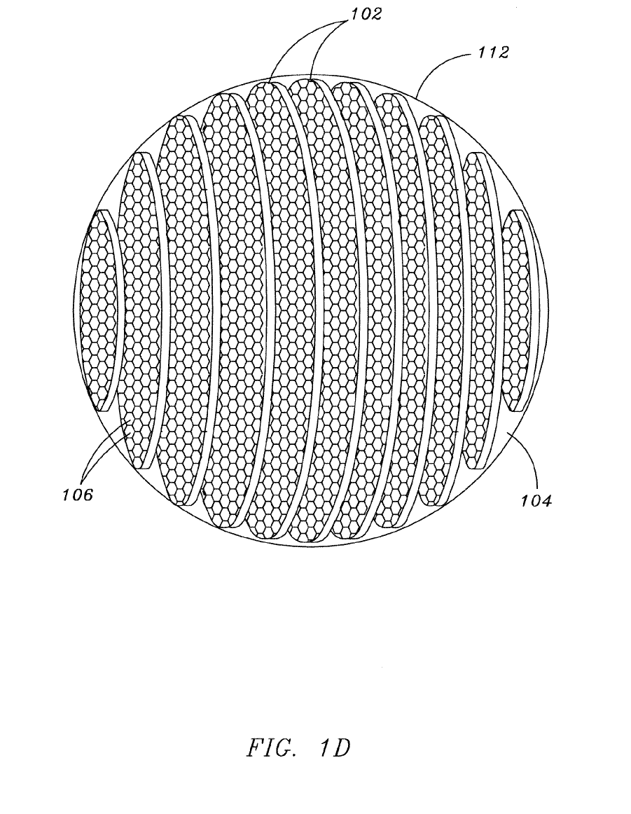

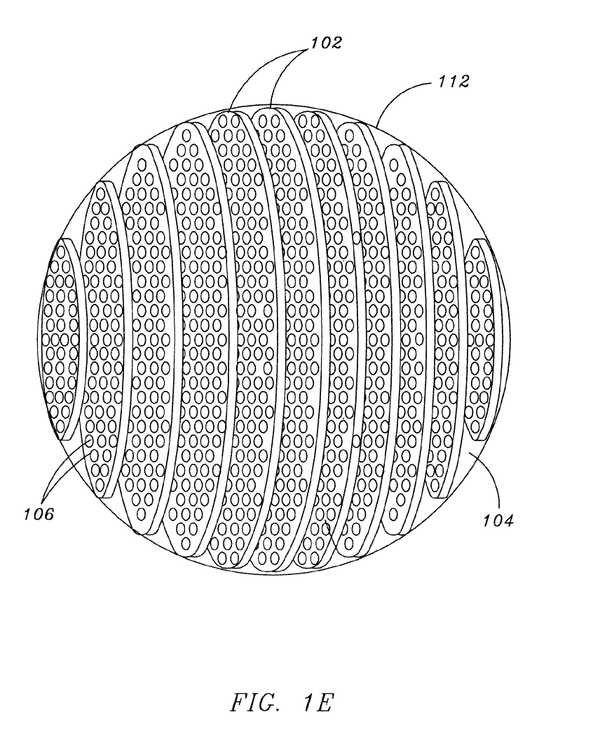

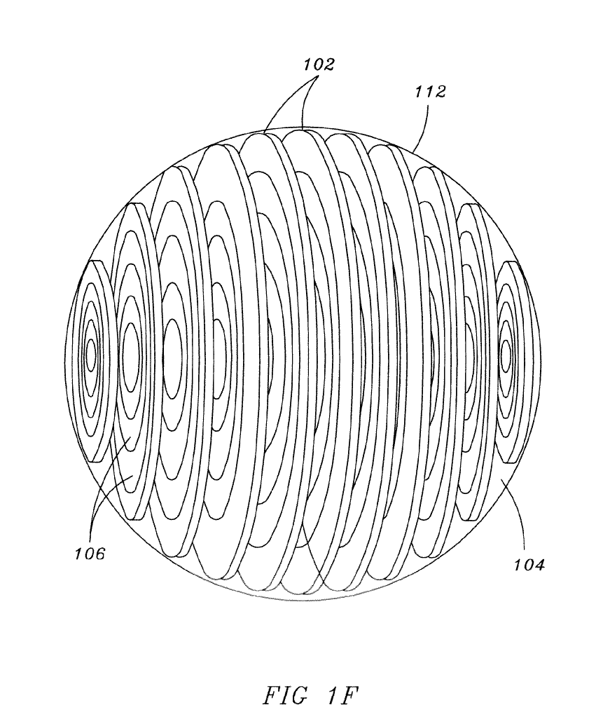

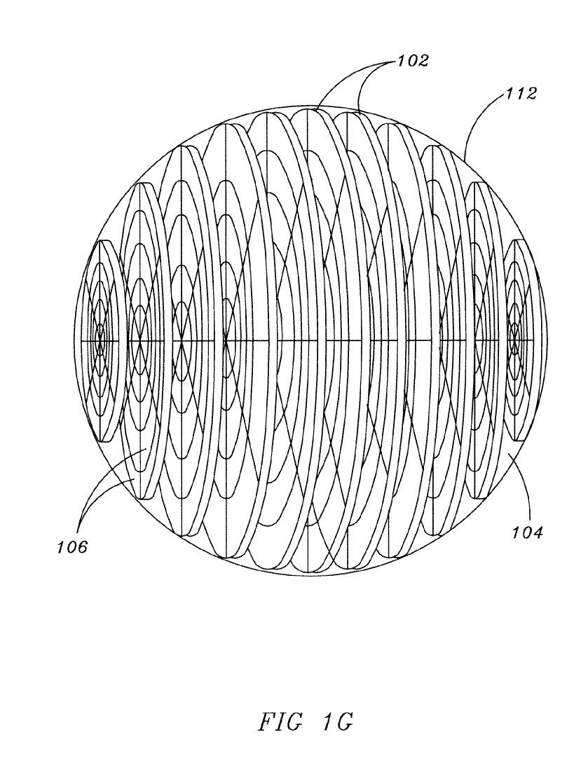

Referring generally to FIGS. 1A through 5D, a solid state neutron detection system 100 suitable for directional and spectral analysis of impinging neutrons is described in accordance with the present disclosure. The neutron detection system 100 may include a plurality of solid state neutron detection devices 101 embedded in a volume of neutron moderating material 104. Additionally, one or more of the neutron detection devices 102 may include two or more neutron detection elements 106 (e.g., independent neutron reactive diode elements) suitable for detecting impinging neutrons. Generally speaking, by spatially resolving the locations of numerous neutron interaction events (capture, induced-fission or scattering events) within the neutron detection system 100, it is possible to deduce the energy spectrum and/or the spatial point of emanation of the impinging neutrons (e.g., omnidirectional incident neutrons, anisotropically incident neutrons, or parallel incident neutrons). Further, the present invention also provides for the very high efficiency detection of neutrons impinging on the neutron detection system 100 over the thermal to fast neutron energy range. Most neutron reactive materials (e.g., boronated materials or lithiated materials) suitable for use in the solid state neutron detecting system 100 are most efficient at capturing thermal neutrons. One way to efficiently capture incident higher energy neutrons (e.g., fast neutrons) is to embed the given solid state detection device 102 at a selected depth within the neutron moderating material 104. As a result, neutron detection devices 102 disposed near the surface of the neutron detection system 100 are more sensitive to thermalized neutrons than neutron detection devices 102 disposed at larger depths, which are more sensitive to initially fast neutrons thermalized by the intervening neutron moderating material 104 (e.g., high density polyethylene). By arranging the solid state neutron detection devices 102 at progressively larger distances from a surface of the moderating material 104 and creating multiple independent solid state neutron detection elements 106 in the various solid state neutron detection devices 102 it is possible to deduce the energy spectrum and the direction of emanation of impinging neutrons captured in the neutron detection elements 106. Real time determination of incident neutron energy and direction of emanation allows for the statistical inference (e.g., using a data collection and processing system) of conditions related to the given neutron source. For example, by measuring the incident neutron energy spectrum (e.g., measuring the amount of incident thermal neutron relative to the amount of incident fast neutrons) and the directionality of incident neutrons it is possible to deduce the type of neutron source (e.g., cosmic-ray production of neutrons, weapons grade plutonium source, or plutonium-beryllium source for scientific research or well logging)). The above depth dependent energy-moderator relationship description for resolving incident neutron energy, direction or for operating in very high efficiency mode generally assumes a single neutron interacting isotope (e.g. ¹⁰B-based boron carbide diodes or ¹⁰B-based boron nitride diodes) as part of the neutron detection devices. It is also possible to tune the type of active neutron interacting isotope or energy dependent microscopic cross section (i.e., use multiple isotopes or combinations thereof at various depths) to gain greater or lesser sensitivity to various energy neutrons at various depths within the moderator material. An example is the use of ²³⁵U, which has a higher cross section for interaction with higher energy neutrons, and ¹⁰B, which has a higher cross section for interaction with lower energy neutrons.

FIGS. 1A through 1M illustrate schematic views of a neutron detection system 100 suitable for the omnidirectional detection and spectral analysis of neutrons, in accordance with an exemplary embodiment of the present disclosure. The neutron detection system 100 may include a plurality of solid state neutron detecting devices 101 embedded in a volume of neutron moderating material 104. Suitable neutron moderating materials include materials with a high content of low atomic weight atoms having a relatively large cross section for neutron scattering but a relatively low neutron capture cross sections, such as hydrogen, boron-11, beryllium, carbon and nitrogen. For example, suitable neutron moderating materials may include water (e.g., light or heavy), organic compounds, such as carbon-based polymers (e.g., high density polyethylene), granular inorganic materials, and graphite. For instance, the plurality of solid state neutron detection devices 101 may be embedded in a volume of high density polyethylene (HDPE). It should be recognized that the use of a HDPE as a neutron moderator 104 is not a limitation and that the solid state neutron detection devices 102 may be embedded or surrounded by other suitable neutron moderating materials. It will be recognized by those skilled in the art that the choice of neutron moderator material will depend on the exact purposes of the given neutron detection system 100 and different moderators may be more or less suitable in different contexts (e.g., size limitations, portability requirements, energy sensitivity requirements, or directional sensitivity requirements). The use of HDPE and other moderator materials for moderating neutrons in a neutron detection setting is described in U.S. Pat. No. 7,514,694 filed on Jun. 19, 2007 is incorporated herein by reference.

In one embodiment, the volume of neutron moderation material may be defined by a three dimensional shape. For example, the volume of moderating material surrounding the plurality of solid state neutron detection devices 101 may include, but is not limited to, a cylinder, a sphere, a cone, an ellipsoid, a cuboid or a hexagonoid. For instance, the plurality of solid state neutron detection devices 101 may be embedded in a cylindrical shaped volume of neutron moderating material. In another instance, the plurality of solid state neutron detection devices 101 may be embedded in a spherically shaped volume of neutron moderating material. It will be recognized by those skilled in the art that the symmetry of the volume of moderation material is such that it allows for a systematic energy-moderation relationship to be determined.

In another embodiment of the present invention, the individual neutron detection devices of the plurality of solid state neutron detection devices 101 may be arranged within a selected detection volume 110. For example, the detection volume may include a three dimensional shape, such as, but not limited to, a cylinder, a sphere, a cone, an ellipsoid, a cuboid, or a hexagonoid. For instance, as shown in FIGS. 1A and 1B, the neutron detection devices of the plurality of detection devices may be arranged such that the surface bounding the detection devices approximately forms a cylinder. In another instance, as shown in FIGS. 1D through 1G, the neutron detection devices 102 of the plurality of detection devices 101 may be arranged such that the surface bounding the detection devices approximately forms a sphere. It will be recognized by those skilled in the art that the choice of detection volume shape may depend on the specific purposes of the neutron detection system 100.

The volume of moderating material 104 may be dimensioned so as to substantially conform to the outer edges of the one or more neutron detection devices 102 of the neutron detection system 100. For example, as shown in FIG. 1D through 1G, the surface of a spherically shaped volume of neutron moderating material may conform to the surface of the detection volume, which serves as a defining boundary to the one or more neutron detection devices.

It is further contemplated that the volume of moderating material 104 need not conform to the outer edges of the one or more neutron detection devices 102 of the neutron detection system 100. For example, as shown in FIGS. 1A and 1B, the surface of a cylindrically shaped volume of neutron moderating material 104 may extend beyond the surface of the detection volume 110, serving as a defining boundary to the one or more neutron detection devices 102. It will be recognized by those skilled in the art that a given neutron detection system 100 may be engineered purposefully such that its moderating volume 104 has a boundary that extends beyond the boundary of the neutron detection devices 102 in order to assist in thermalizing incident neutrons so as to improve detection efficiency. For instance, Monte Carlo calculations, for a simulated unmoderated Pu source, have shown a cylindrical moderating volume having a 8 cm radius and 10 cm axial length produces significantly improved spectroscopic resolution, directional resolution, and efficiency (i.e., attaining very high efficiency) compared to a cylindrical moderating volume having a 1 cm radius and 1 cm axial length. The increase in sensitivity was observed both when incident neutrons impinged the neutron detection system 100 at a direction normal to the top 114 of the detector system 100 and at a direction normal to the lateral edge 116 of the detector system.

Further, as shown in FIGS. 1A through 1C, the individual solid state detection devices 102 that make up the plurality of solid state detection devices 101 may have a substantially planar shape. For example, one or more of the solid state neutron detection devices 102 may include a solid state neutron detection device 102 having a geometrical shape with very high aspect ratio (i.e., very thin). For instance, the solid state neutron detection devices 102 may include flat circular shaped solid state neutron detection devices. A variety of geometrically shaped neutron detection devices 102 are suitable for use in the solid state neutron detection system 100, including, but not limited to, rectangles (e.g., squares), ellipses, triangles, or hexagons. It is further contemplated that, while planar shaped solid state detection devices 102 may serve as the most easily fabricated devices, devices may also be fabricated individually and embedded at the locations necessary to obtain a coordinate dependence of the neutron capture, induced-fission or scattering intensity. It should be recognized by those skilled in the art that the use of planar solid state neutron detection devices 102 is not a limitation and that the implemented solid state neutron detection devices 102 may have a substantially non-planar character (e.g., devices having low aspect ratio) as long as they represent a volume along a determined coordinate axis. For instance, one or more of the solid state neutron detection devices may have a ribbon shape, or packing of cubes, or any shape capable of allowing electron-hole pair separation.

Referring to FIGS. 1A through 1H, the plurality of solid state neutron detection devices 101 may be disposed within a neutron moderator material 104 such that one or more of the solid state neutron detection devices 102 are aligned in a substantially parallel manner. For example, as shown in FIG. 1A, eight individual solid state neutron detection devices 102 are aligned such that the surfaces of the individual devices are substantially parallel with respect to one another. Generally, a first detection device, a second detection device, and up to and including an Nth detection device may be aligned such that the surfaces of the individual devices 102 are substantially parallel with respect to one another. It will be recognized by one skilled in the art that the use of parallel aligned solid state neutron detection devices 102 is not an essential requirement and that devices arranged in a non-parallel fashion may implemented. For example, a first solid state neutron detector device 102 may be aligned perpendicularly with respect to one or more of the other solid state neutron detector devices 102. More generally, a first solid state neutron detector device 102 may be aligned at a selected angle with respect to one or more of the other solid state neutron detector devices 102. It is further contemplated that a portion of the plurality of solid state neutron detection devices 101 may be aligned along a first direction while an additional portion of the plurality of solid state neutron detection devices 101 is aligned along an additional direction, the additional direction oriented at a selected angle with respect to the first direction.

The plurality of solid state detection devices 101 of the neutron detection system 100 may include a ‘stack’ of a selected number of individual solid state detection devices 102. For example, a stack of a selected number of substantially planar and parallel aligned solid state neutron detecting devices 102 may be embedded within a volume of a chosen neutron moderating material 104. For instance, as shown in FIGS. 1A and 1B, a stack of eight substantially planar and parallel aligned solid state neutron detection devices 102 are embedded within a volume of a selected moderating material 104. It should be recognized by those skilled in the art that the use of eight devices is not a limitation and that the neutron detection system 100 may employ an arbitrary number of solid state detection devices 102, based on the specific demands on the detection system 100. In general, it should be appreciated by those skilled in the art that increasing the number of solid state detection device layers in the neutron detection system 100 may improve both neutron capture efficiency and neutron spectral and directional measurement accuracy up to the limit at which the moderator in between planar devices compromises the scattering-energy (i.e., moderation) relationship.

Moreover, the neutron detection devices 102 of the plurality of neutron detection devices 101 may be positioned along a common orientation axis. For example, as illustrated in FIGS. 1A and 1B, the neutron detection devices 102 may be spaced linearly along an axial direction. For instance, the neutron detection devices 102 within a stack of neutron detection devices may be periodically spaced along a common axis at 1 cm intervals. In another instance, the neutron detection devices 102 within a stack of neutron detection devices may be periodically spaced along a common axis at 0.025 cm intervals. As shown with Monte Carlo simulations, an increase in depth resolution of neutron capture events occurs upon increasing the number of neutron detection devices per unit length. For example, the applicants have shown a cylindrical stack of neutron detection devices 102 embedded in a high density polyethylene moderator having a spacing of 0.2 cm (i.e., 5 neutron devices/cm) displays an increased depth resolution when compared to a device spacing of 1 cm (i.e., 1 neutron device/cm). It should be recognized by those skilled in the art that the specific linear spacing interval of neutron detection devices 102 is not a limitation and that various spacing intervals may be used in a solid state neutron detection system 100, with the specific spacing chosen according to specific efficiency, accuracy, and sensitivity requirements of the given system.

By way of another example, as shown in FIG. 1G, the neutron detection devices 102 may be spaced nonlinearly along a common axis. For instance, the neutron detection devices 102 within a stack of neutron detection devices may be spaced along a common axis at intervals of 0.5, 1.0, 1.5, 2.0, 3.0, 5.0, 7.5, 10, 15, and 20 cm, as measured from a surface of the surrounding neutron moderating material 104. It should be recognized by those skilled in the art that the specific nonlinear spacing intervals of neutron detection devices 102 is not a limitation and that various spacing intervals may be used in a solid state neutron detection system 100, with the specific spacing chosen according to specific efficiency, accuracy, and sensitivity requirements of the given system for a known incident neutron energy (i.e., neutron moderation is not perfectly linear between depth and energy).

Referring again to FIG. 1G, a portion of the surface of the volume of moderating material 104 of the neutron detection system 100 may be covered with a neutron reflector material 120. Materials suited for neutron reflection typically include materials having a larger cross section for neutron scattering while having a lower (or even no) cross section for neutron capture, so that the material acts to effectively scatter the incident neutrons in an elastic manner (although inelastic scattering is also possible, especially at higher neutron energies). For example, a suitable neutron reflector material 120 may include, but is not limited to, a material containing tungsten carbide, tungsten deuteride, carbon-deuteride, or lithium-deuteride, steel, or lead. In addition, simply increasing a standard moderator volume, such as high density polyethylene, beyond the device volume can lead to a neutron reflection contribution. For example, a cylindrical detection region 110 embedded in a cylindrical moderating volume 104 may be partially covered by a layer of carbon-deuteride. It should be recognized by those skilled in the art that materials having light atoms may also be readily used as a reflector material 120. For example, a suitable light weight reflector 120 may include, but is not limited to, materials containing beryllium, or graphite. In the case of materials having light atomic constituents, the effect of inelastic readily occurs in these materials may need to be considered.

The addition of a reflector 120 layer acts to reflect neutrons that would otherwise pass through the detection 110 and moderator 104 volumes of the neutron detection system 100, allowing for more efficient collection of neutron interaction events, such as neutron capture. The applicants have shown that the use of a polyethylene or beryllium reflector layer concentric to a cylindrical geometry acted to increase the overall neutron capture efficiency by 30 percent from the non-reflected setting.

In addition, a portion of the surface of the volume of moderating material 104 of the neutron detection system 100 may be covered with a neutron blocker 121 material. As shown in FIG. 1G, the neutron blocker 121 may be operably coupled to the outside of the neutron reflector material 120, such that the blocker material substantially conforms to the outside of the reflector material 120. Alternatively, the neutron blocker 121 may be operably coupled to the outside of the neutron moderating material 104 directly with no neutron reflector 120 present, such that the blocker material substantially conforms to the outside of the moderator material 104. A suitable material for a neutron blocker 121 include, cadmium-113, boron-10, borated aluminum, or borated polyethylene. In general, any material that is effective in blocking or stopping neutrons should serve as an effective neutron blocker 121. The use of a neutron blocker 121 may allow for the construction of a neutron detection system 100 that preferentially allows for the passage of neutrons through a selected surface, as shown in FIG. 1G. This preferential passage of neutrons into the neutron detection volume 110 produces a camera effect, which may aid in allowing only substantially parallel neutrons into the detection volume 110. Moreover, this camera effect may enhance the directional resolution of neutrons emanating from a given neutron source.

Referring again to FIGS. 1C and 1l, one or more of the plurality of solid state neutron capture devices 101 may include one or more solid state heterostructures. Those skilled in the art will recognize that all solid-state devices that generate and separate electron-hole pairs do so through a heterostructure geometry. For example, one or more of the solid state neutron capture devices 102 may include a multilayer geometry capable of separating electron-hole pairs created by the primary reaction products resulting from a neutron capture event, neutron-induced-fission, or a neutron scattering (e.g., proton recoil) event in the device (and/or moderator unless moderator is included in “device”) volume. Those skilled in the art will appreciate that there are three general types of heterostructures. They include the dielectric, the p-n junction diode and the Schottky diode. For the purposes described herein, the important characteristic of a solid state heterostructure is its ability to separate electron-hole pairs. Further, some heterostructures require external bias to extract electron-hole pairs (e.g., dielectric device). In contrast, however, p-n junctions and Schottky devices do not necessarily require an external bias to sweep out electron-hole pairs, although an external bias generally aids in the process.

For the solid state neutron detector class in which the internal electrical field (required to separate e-h pairs before they recombine) is produced only by an external voltage, (i.e., a resistive or dielectric device) the dielectric is a direct-conversion material that acts to both capture neutrons as well as transduce the primary neutron capture reaction products. In the case of p-n junction and Schottky-based solid-state neutron detector heterostructures, two subclasses are delineated: (1) indirect-conversion devices (a.k.a., thin-film-coated or conversion layer devices) and (2) direct-conversion devices (a.k.a., solid-form devices). For indirect-conversion heterostructure geometries a thin film of a neutron-sensitive material (i.e. containing but not limited to ³He, ⁶Li, ¹⁰B, ¹⁵⁷Gd, or ²³⁵U) is placed within range so that the scattering or reaction capture product(s) (i.e., moderate-energy ions) may create electron-hole pairs in an adjacent space charge device. In contrast, for direct-conversion heterostructures, the neutron-sensitive material and space charge layer are the same.

In one embodiment of the present invention, one or more of the neutron detection devices 102 used to detect impinging neutrons may include a boron carbide (B₅C) or boron nitride (BN) direct conversion heterojunction diode. Boron carbide heterojunction diode devices and their fabrication are described in U.S. Pat. No. 6,771,730 issued on Aug. 3, 2004 and is incorporated herein by reference.

In an additional embodiment of the present invention, one or more of the neutron detection devices 102 used to detect impinging neutrons may include an indirect or conversion layer solid state neutron detector device. Conversion layer diode devices and their fabrication are described in U.S. Pat. No. 6,479,826 issued on Nov. 12, 2002 and is incorporated herein by reference.

As illustrated in FIG. 1l, the solid state neutron detection elements 106 of one or more of the neutron detection devices 102 embedded within the neutron moderator 104 may be fabricated using standard metallization techniques for two-dimensional readout. The geometry of the contacts may be such that each degree of freedom is disposed orthogonally on the opposing face of a heterostructure, so that external contact may be made at the edge or by a continuous ground/common plane on one side of a heterostructure, with individual contacts on the opposing side requiring external contact in the middle of the heterostructure.

It is further contemplated that the described contacts may be applied by a number of deposition methods including, but not limited to, thermal evaporation, electron beam evaporation, atomic layer deposition, rf/dc magnetron/non-magnetron sputtering, pulsed laser deposition, plasma enhanced chemical vapor deposition or by thermal chemical vapor deposition.

Moreover, the individual neutron detection elements 106 described herein, may be created using a variety of patterning techniques. For example, patterning of the metal may be achieved with wet or dry lithographic techniques or shadow masking techniques. It should be recognized by those skilled in the art that these do not represent limitations on the preferred patterning technique but merely examples and that this concept may be extended to other analogous patterning techniques.

In addition, it is further contemplated that the contact size and the contact spacing are limited by the carrier drift/diffusion length in the heterostructure semiconductor. This limitation includes the drift length with finite bias, as well as the mean free path of the primary reaction products from neutron capture, scattering or induced fission. These lengths are typically 2 to 100 microns. Therefore, under normal conditions, the contact size will range between hundreds of microns to a few centimeters. It is possible, however, with proper selection of materials and conditions, to reduce the contact size to as small as 10 microns, while surface areas as large as 10 to 1000 sq. centimeters may be used provided the large capacitance is not prohibitive. Further, spacing between contacts should at a minimum be on the order of ten to hundreds of microns. It should be appreciated by those skilled in the art that the detection element described and illustrated in FIG. 1l does not serve as a limitation on the present invention but serves merely as one configuration of the present invention. It should be recognized that the concepts described in the above description may be extended to other solid state devices suitable for neutron detection.

It is further contemplated that the neutron detection elements 106 of a given neutron detection device 102 may be wired independently from one another. In so doing, the electrical response of an incident neutron flux at a given neutron detection element 106 may be transmitted to a data processing system independent from the other neutron detection elements 106 in the same neutron detection device 102. This capability allows for a true two dimensional pixilated interpretation of an incident neutron distribution across a given neutron detection device surface, providing for improved three dimensional resolution. It should, however, be recognized by those skilled in the are that some neutron detection elements may also be coupled in parallel and/or series so as to provide detection element 106 redundancy throughout a given detection device.

Referring now to FIGS. 1J through 1M, one or more of the solid state neutron detection elements 106 of one or more of the solid state neutron detection devices 102 may include detection elements 106 having a geometrical shape. For example, a solid state neutron detection element 106 may include, but is not limited to, a solid state neutron detection element 106 having, from a top view, the shape of a circle, a portion of a circle, a hexagon, a rectangle (e.g., a square), a ring, an ellipse, or a triangle. For instance, as shown in FIG. 1J, the solid state neutron detection devices 102 may contain a number of hexagonal shaped solid state neutron detection elements 106. In another instance, as shown in FIG. 1K, the solid state neutron detection devices 102 may contain a number of circular shaped solid state neutron detection elements 106. In an additional instance, as shown in FIG. 1L, the solid state neutron detection devices 102 may contain a number of concentric ring shaped solid state neutron detection elements 106. Further, as shown in FIG. 1M, the solid state neutron detection devices 102 may contain a number of solid state neutron detection elements 106 having a sectioned concentric ring shape. It should be recognized by those skilled in the art that the use of the described shapes for the solid state neutron detection elements 106 is not a limitation and that the implemented solid state neutron detection elements 106 of the solid state neutron devices 102 may have a variety of geometrical shapes.

Moreover, it should be noted that the individual solid state neutron detection elements 106 may have a substantially three dimensional character. For example, as shown in FIG. 1C, the volume of a hexagonal shaped detection element 106 may extend along the axial direction of the detection device 102 below the planar surface of the detection device 102. It is this entire elemental volume (i.e., a voxel) that serves as the neutron detection (e.g. via neutron capture, neutron-induced fission, or scatter) element 106. The volumetric extent of a given three dimensional element 106 is fixed by 1) the areal contact size used and 2) the device thickness, as illustrated in FIGS. 1C and 1G respectively. For example, a typical solid state neutron detection element 106 of the present neutron detection system 100 may have a surface area of 100 cm² and a neutron sensitive thickness of 2 μm or thicker for a direct conversion heterostructure and 2.4 μm or less for an indirect conversion heterostructure. It should be appreciated by those skilled in the art that the described shape and dimensions of the three dimensional solid state neutron detection elements are not limitations and the general concept described herein can be extended to a variety of configurations.

In addition, the two or more solid state neutron detection elements 106 of one or more of the solid state neutron detection devices 102 may be distributed according to a geometrical pattern of a symmetry that allows for a coordinate dependence. For example, the individual neutron detection elements 106 may be disposed within a solid state neutron detection device 102 in a hexagonal pattern. For instance, as shown in FIG. 1J, the hexagonal shaped detection elements 106 may be distributed in a hexagonal distribution to yield a polar coordinate system. In another instance, as shown in FIG. 1K, the circular shaped detection elements 106 may be distributed in a hexagonal distribution. It should be recognized by those skilled in the art that the use of a hexagonal distribution of the neutron detection elements 106 is not a requirement of the neutron detection system 100 and that the implemented solid state neutron detection elements 106 of the solid state neutron devices 102 may be distributed in a variety of geometrical arrangements. For example, neutron detection elements 106 may be distributed in a two dimensional ‘n×m’ rectangular array wherein a Cartesian coordinate system will be most applicable. In another example, shown in FIGS. 1L and 1M, neutron detection elements 106 may be distributed in a circular or sectioned circular pattern. For an omnidirectional neutron source, a spherically symmetric system (moderator+devices+element distribution) is most advantageous as the radial dependence is most directly proportional (i.e., least convoluted) to neutron energy while still providing the highest efficiency. In contrast, the cylindrical or cuboid geometry is most advantageous for known parallel incident neutrons, whereas the spherical symmetry is best if the neutrons are incident parallel but from an unknown direction or if there is a mixture of parallel and omnidirectional incident neutrons.

Referring again to FIGS. 1A through 1G, the plurality of the solid state neutron detection devices 102 and the surrounding neutron moderating material 104 may be engineered such that the overall neutron detection system 100 is substantially defined by a three dimensional shape. For example, the shape of the neutron detection system 100 may include, but is not limited to, a cylinder, sphere, an ellipsoid, a cone, a cuboid, or a hexagonoid. For instance, as shown in FIGS. 1A and 1B, the neutron detection devices 102 and the neutron moderating material 104 may be arranged such that the overall neutron detection system 100 is substantially defined by a cylinder. In another instance, as shown in FIGS. 1D through 1G, the neutron detection devices 102 and the neutron moderating material 104 may be arranged such that the overall neutron detection system 100 is substantially defined by a sphere. It will be recognized by those skilled in the art that the choice of shape of the neutron detection system 100 will depend on the specific purposes of the neutron detection system 100. The applicants have found that a cylindrically shaped detection volume 110 is preferred in analyzing incident neutron characteristics when the incident neutrons have a preferential direction or of parallel incidence. It has been further found by the applicants that a spherically shaped detection volume 110 is preferred in analyzing impinging neutron properties of omnidirectional neutrons. For instance, a cylindrically shaped detection volume 110 may be preferred in analyzing impinging neutron properties when the neutron source type and location is known, such as in a scientific research or nuclear medicine. In contrast, a spherically shaped detection volume may be preferred when the impinging neutron energy and direction are unknown, such as settings attempting the detection of a weapons grade Pu source.

Additionally, the positioning of the neutron detection elements 106 of one or more of the neutron detection devices 102 of the neutron detection system 100 may be chosen to conform to the preferred coordinate system of the given neutron system geometry to provide the most direct moderator-energy relationship under the spectroscopic embodiment. For example, in a cylindrically shaped neutron detection system 100 the distribution of neutron detection elements 106 may conform to a cylindrical based coordinate system. In another example, neutron detection elements 106 in a spherically shaped neutron detection system 100 may be distributed in accordance with a spherical coordinate system. By way of further example, in a cuboid shaped neutron detection system 100 the distribution of neutron detection elements 106 may adhere to a x, y, z Cartesian coordinate system. Those skilled in the art will recognize that the above geometries do not serve as limitations and the concept describe above may be readily applied to other geometries.

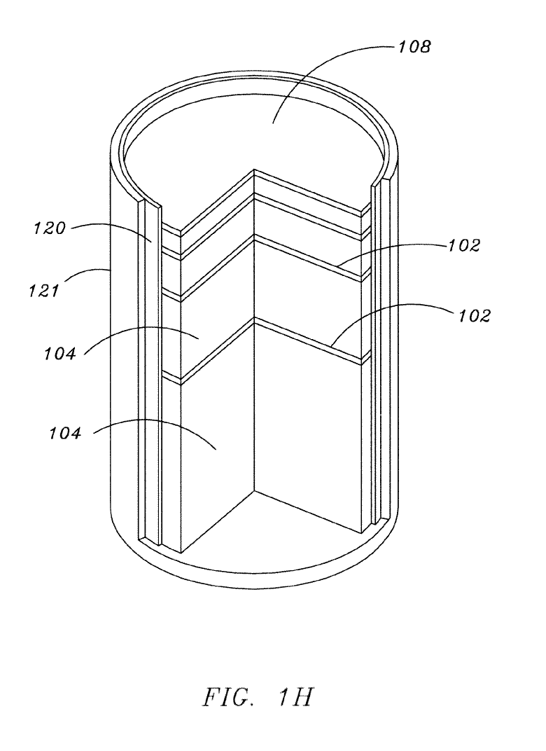

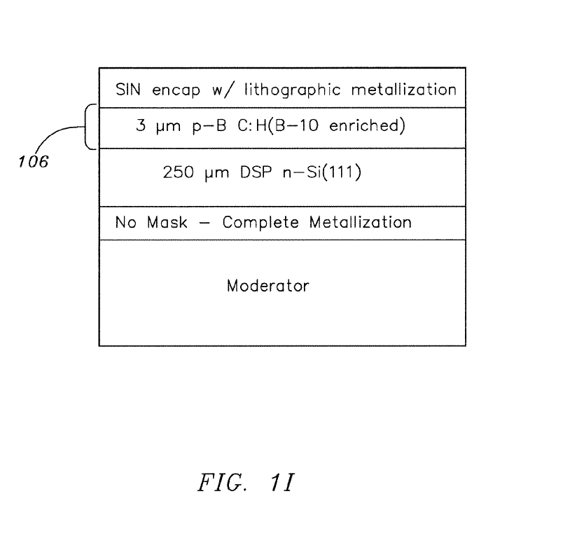

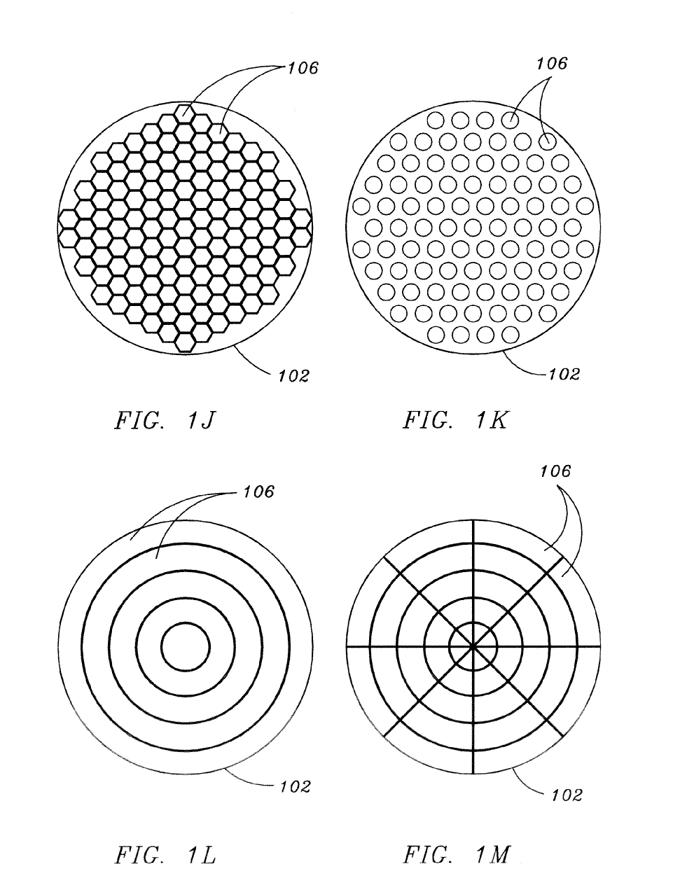

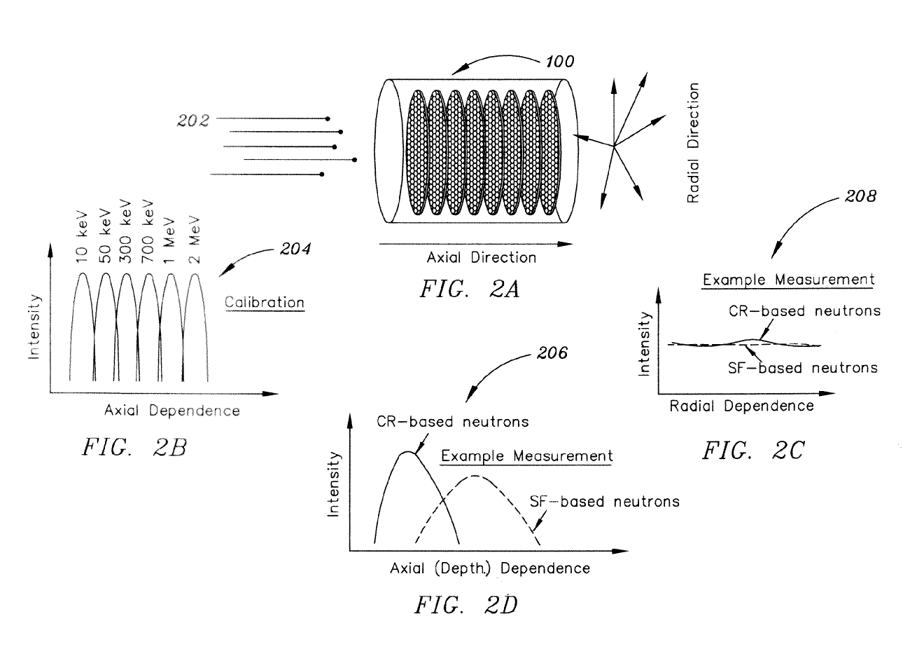

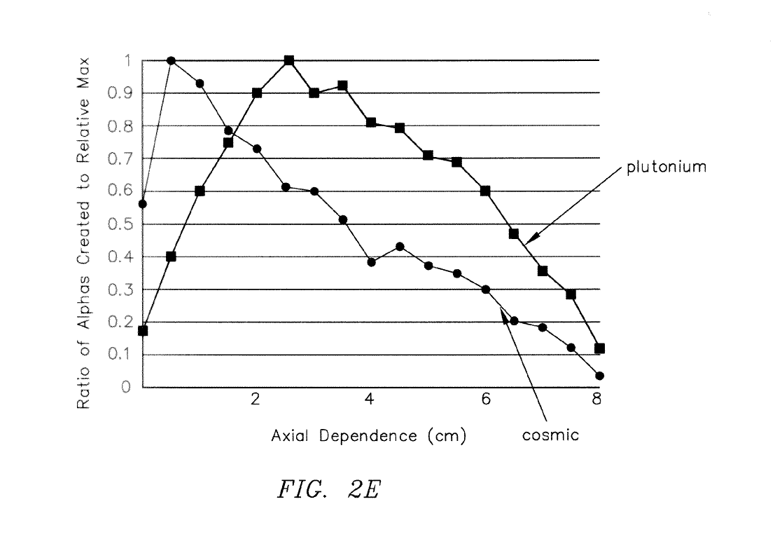

Referring now to FIG. 2A through 2E, a cylindrically symmetric shaped neutron detection system 100 may be implemented to measure the energy spectrum of neutrons impinging on the face perpendicular to the long axis or axial direction 202 (i.e., normal to the surface of the individual neutron detection devices) of the neutron detection system 100. One skilled in the art will appreciate that in a cylindrical geometry, as depicted in FIG. 2A, assuming parallel incidence of impinging neutrons, the depth at which a number of detected neutron capture events is maximum (i.e., the depth of the neutron detection device that is most frequently triggered) is proportional to the energy of the incident neutrons.

In one implementation of the cylindrical neutron detection system 100, assuming parallel incidence of impinging neutrons 202, the neutron detection system 100 may be calibrated in depth using multiple monoenergetic neutron sources. For example, the neutron detection system 100 may be exposed to six monoenergetic neutron sources emitting neutrons having energy distribution peaks at 10 keV, 50 keV, 300 keV, 700 keV, 1 MeV, and 2 MeV respectively, as displayed by the hypothetical calibration data sets shown illustrated in FIG. 2B. It should be recognized by those skilled in the art that the use of six known monoenergetic sources is not a limitation and that more or less sources may be used at greater or lesser energies, where the selected number of sources and energy distributions of the given sources will depend on the required accuracy, need for deconvolution and the neutron source that is sought to be analyzed. After building up appropriate calibration data sets, and thus correlating the penetration depth with actual incident neutron energy, the cylindrical neutron detection system 100 may then be used to measure the energy spectrum of incident neutrons at or less than 100 keV, as shown in the hypothetical data sets 206 and 208. Moreover, knowing that the energy distribution for neutrons produced by a spontaneous fission Pu source has an energy peak at approximately 900 keV and the energy distribution for cosmic-ray induced spallation neutrons has a peak at approximately 400 keV, by comparing the measured penetration depth data (flux vs. depth or intensity vs. depth) to the calibration data from the monoenergetic neutrons (flux vs. depth or intentsity vs. depth for known energy), a spectrum (flux vs. energy or intensity vs. energy) can be deduced and it is possible to then further deduce the type of neutron source. It is further contemplated that for the purposes described in the present disclosure the terms “flux” and “intensity” are substantially interchangeable as intensity represents the total number of neutrons that have impinged at a given detector element, whereas flux represents the total number of impinging neutrons per unit area per unit of time. It should be recognized by those skilled in the art that an intensity value is readily converted to a flux value and vice-versa based on the length of time of a given measurement.

By way of further example, calibration data may be built up using known energy spectrums. For example, as shown in FIG. 2D, if the purpose of a given detection system 100 is to detect spontaneous fission neutrons from an actnide or actnoid source then a suitable calibration data measurement may entail separately exposing the given device to a suitable spontaneous fission source (e.g., ²³⁹Pu) and cosmic-ray induced spallation neutrons while in the absence of a Pu source in order to calibrate the response of the embedded neutron detection devices to those energy sources. It should be noted that the hypothetical data set displayed in FIG. 2D represents hypothetical deconvoluted energy spectrums from cosmic ray induced neutrons and spontaneous fission produced neutrons. The actual measured energy spectrum while in the presence of these two sources may comprise a superposition of the two peaks represented in FIG. 2D. The convoluted peaks may then be deconvoluted using appropriately employed fitting software. Then, using the calibration data from the Pu source and cosmic ray sources, it is possible to deduce the relative contributions of Pu source neutrons and cosmic ray produced neutrons by comparing, via statistical analysis, the calibration data to measured data.

By way of a final example, as shown in FIG. 2E, theoretical calculations may be used to model a given source. For example, the applicants have shown using Monte Carlo based calculations that using a neutron detection system 100 with high density polyethylene (HDPE) having a 0.5 cm spacing between neutron sensitive elements, that the depth at which the number of detected events is maximum should occur at approximately 1.5 and 2.5 cm for cosmic ray induced spallation and spontaneous fission produced neutrons respectively, as shown in FIG. 2E. The theoretical model may then be used to calibrate the neutron detection system 100 in a manner consistent with the approach contemplated in the preceding description.

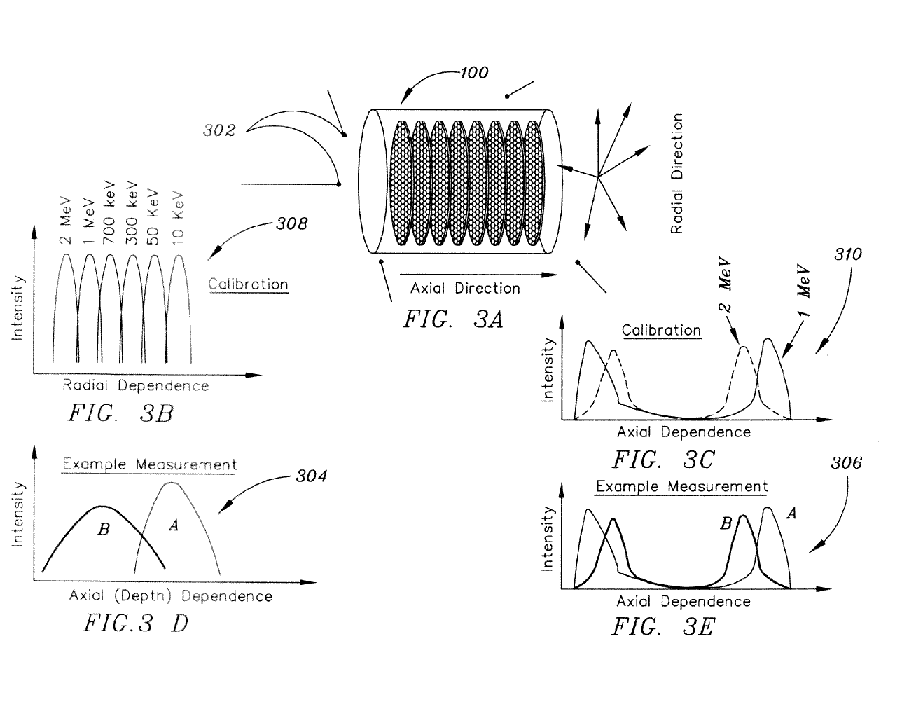

Referring now to FIG. 3A through 3E, a cylindrically symmetric shaped neutron detection system 100 may be utilized to measure the energy spectrum of omnidirectional incident neutrons impinging on all faces of the neutron detection system 100. One skilled in the art will appreciate that in a cylindrical geometry, as depicted in FIG. 3A, assuming omnidirectional incidence of impinging neutrons 302, the depth at which a number of detected neutron capture events is maximum (i.e., the depth of the neutron detection device that is most frequently triggered) is proportional to the energy of the incident neutrons 302. To accomplish the depth resolution for omnidirectional incidence on the cylindrical geometry, both a radial 304 and axial 306 dependence of intensity must be determined. While the axial dependence 306 is determined in a manner similar that that described in the preceding description, the radial dependence may be formed by a number of neutron detection elements 106 (e.g., metalized contacts) which create a pixilated effect, forming approximately concentric detection rings as shown in FIG. 1K. In a manner described in the preceding section, both radial 308 and axial 310 directions require calibration by monoenergetic neutrons, known neutron energy spectrums or theoretical calculations in order to provide the moderator-energy correlation.

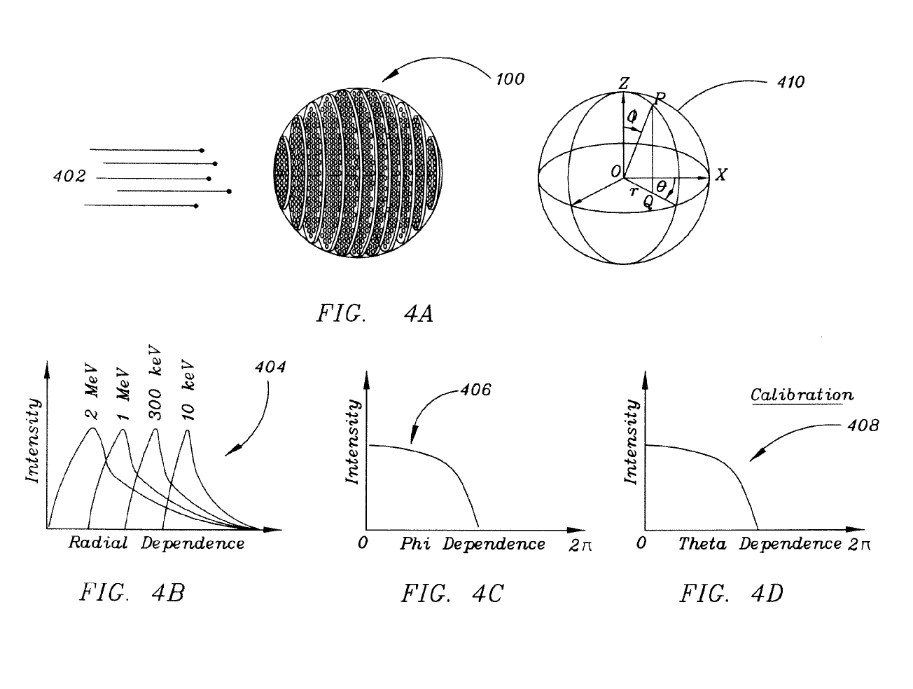

Referring to FIG. 4A through 4D, a spherically symmetric shaped neutron detection system 100 may be utilized to measure the energy spectrum of parallel incident neutrons impinging normal to any tangent on the sphere. One skilled in the art will appreciate that in the spherical geometry 410, as depicted in FIG. 4A, assuming parallel incidence of impinging neutrons 402, the radial depth at which a number of detected neutron capture events is maximum in less than one hemisphere, is proportional to the energy of the incident neutrons 402. To accomplish the depth resolution for parallel incidence on the spherical geometry, the radial 404, phi 406 and theta 408 dependence of the intensity must be determined. To provide the greatest spectroscopic clarity, the sphere radius should be greater than the macroscopic mean free path of the most energetic neutron to be detected, but not so large that the most energetic neutrons terminate outside the quarter radius. Detection element 106 pixilation may be formed as described in preceding description.

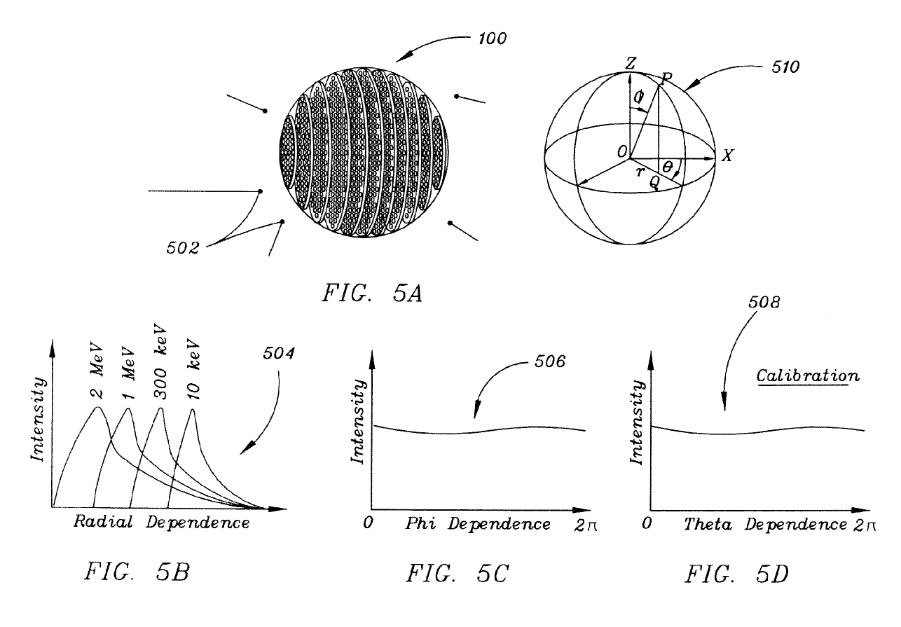

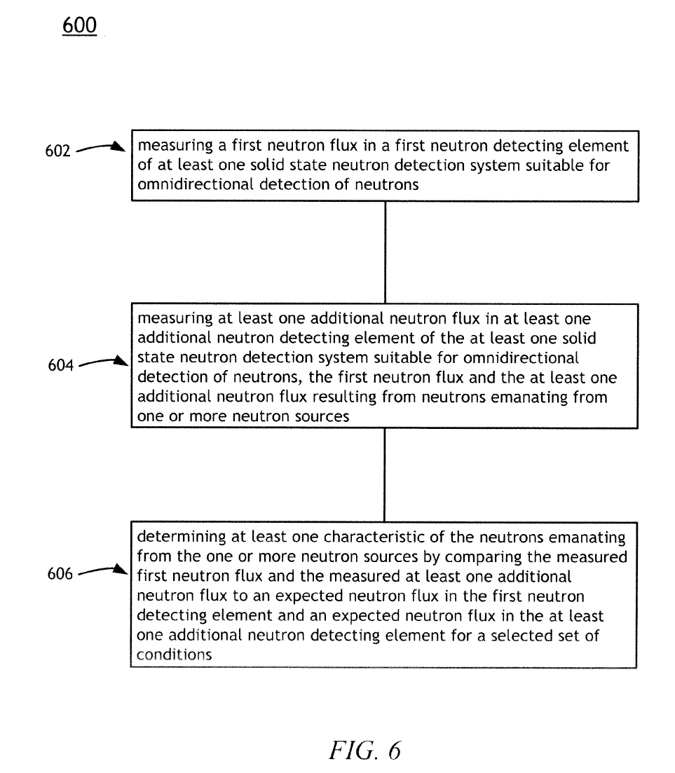

Referring to FIG. 5A through 5D, a spherically symmetric shaped neutron detection system 100 may be implemented to measure the energy spectrum of omnidirectional neutrons 502. One skilled in the art will appreciate that in a spherical geometry 510, assuming omnidirectional incidence of impinging neutrons, the radial depth at which a number of detected neutron capture events is maximum (i.e., the depth of the neutron detection device that is most frequently triggered) is directly proportional to the energy of the incident neutrons. The volume of elements and moderator-energy correlation calibration may be completed as described above.

It is further contemplated that the detection system geometry and symmetry described above may be extended to the conical, pyramidal, cuboid and other rotationally and/or mirror plane invariant symmetries in order to obtain a coordinate dependence of the intensity from which incident neutron energy may be determined.

Following is a description of a series of flowcharts depicting implementations of a neutron detection system 100 configured for omnidirectional detection and spectroscopic analysis of impinging neutrons. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Referring to FIG. 6 a flow chart depicting an implementation of a neutron detection system 100 configured for omnidirectional detection and spectral analysis of impinging neutrons is illustrated. Those having skill in the art will appreciate that the style of presentation utilized herein generally allows for a rapid and easy understanding of the various process implementations. In addition, those skilled in the art will further appreciate that the style of presentation used herein also lends itself well to modular and/or object-oriented program design paradigms.

FIG. 6 illustrates an operational flow representing example operations related to the omnidirectional detection and spectral analysis of neutrons using the neutron detection system 100 described herein. In FIG. 6 where various examples of operational flows, discussion and explanation may be provided with respect to the above-described examples of FIGS. 1A-5D and/or with respect to other examples and contexts. However, it should be understood that the operational flows may be executed in a number of other environments and contexts, and/or in modified versions of FIG. 6. In addition, although the various operational flows are presented in the sequence(s) illustrated, it should be understood that the various operations may be performed in other orders than those that are illustrated, or may be performed concurrently.

Referring now to FIG. 6, a method 600 for the omnidirectional detection and spectral analysis of neutrons is illustrated. Step 602 depicts measuring a first neutron flux in a first neutron detection element of at least one solid state neutron detection system suitable for omnidirectional detection of neutrons. As shown in FIGS. 1A-5D, a first neutron detecting element 106 of a solid state neutron detection device 102 (e.g., p-n diode, Schottky diode or a dielectric device) of a neutron detection system 100 may measure the impinging neutron flux by measuring the charge pulses created by the transduction of one or more of the primary reaction products of the neutron interaction events (e.g., via neutron capture, neutron-induced fission, or scattering) in the detector material of the first detection element 106. For example, as shown in FIGS. 1A through 5D, a first neutron detection element 106 of a first solid state neutron detection device 102 of a spherical neutron detection system 100 may measure the impinging neutron flux on the first neutron detection element 106.

Step 604 depicts measuring at least one additional neutron flux in at least one additional neutron detection element of the at least one solid state neutron detection system suitable for omnidirectional detection of neutrons, the first neutron flux and the at least one additional neutron flux resulting from neutrons emanating from one or more neutron sources. As shown in FIG. 2A through 5D, at least one additional neutron detection element 106 of at least one neutron detection device 102 of a neutron detection system 100 may measure the impinging neutron flux by measuring the charge pulses created by the neutron interaction events in the detector material of the at least one detection element 106. For example, a second neutron detection element 106 of a second solid state neutron detection device 102 of a spherical neutron detection system 100 may measure the impinging neutron flux on the second neutron detection element 106. It should be noted that the second detection element need not reside in the second detection device and the above description of such should not be interpreted as a limitation. For example, the second neutron detection element may reside in the first detection device or a third detection device, or more generally an Mth detection element 106 may reside in an Nth detection device 102.

Moreover, the method described herein is not limited to two device elements. Rather, generally up to and including an M number of device elements may be used applying concepts identical to those described in the preceding description.

Further, it should be appreciated that in a single implementation of the method described herein the neutron flux may be measured at a first neutron detection element 106, a second neutron detection element 106, a third neutron detection element 106, and up to and including an Mth neutron detection element 106.

It will be further appreciated by those skilled in the art that the electrical response in each of the individual elements 106 (first through Mth) may then be transmitted via electrical contact wires (e.g., copper wires) to a signal processing system (e.g., computer programmed system) configured to correlate the electrical responses in each of the solid state neutron detection elements to a neutron flux reading for each detection element. It should be appreciated by those skilled in the art that in addition to the detection elements and signal transmitting wires additional circuitry elements (e.g., pre amp) typically present in solid states systems such may be present.

It should further be recognized by those skilled in the art that the geometry described herein is not a limitation of the described method and a variety of neutron detection systems having varying geometries (e.g., cylindrical or cuboid) are suitable for the purposes described herein.

Step 606 depicts determining at least one characteristic of the neutrons emanating from the one or more neutron sources by comparing the measured first neutron flux and the measured at least one additional neutron flux to an expected neutron flux in the first neutron detection element and an expected neutron flux in the at least one additional neutron detection element for a selected set of conditions. As shown in FIG. 2A through 5D, at least one characteristic of the neutrons impinging on the neutron detection system 100 may be determined by comparing the measured first neutron flux and the measured at least one additional neutron flux to an expected neutron flux in the first neutron detection element 106 and an expected neutron flux in the at least one additional neutron detecting element 106 for a selected set of conditions. For instance, a characteristic of the impinging neutrons that may be determined by comparing the measured neutron flux readings to expected neutron flux readings include, but is not limited to, neutron energy, neutron energy spectrum, spatial point of emanation of a portion of the neutrons, or source of the neutrons. Moreover, the source of neutrons may include, but is not limited to, a thermal neutron source, a fast neutron source, a thermal and fast neutron source, a moderated fast neutron source, a spontaneous fission source, cosmic-ray induced spallation, a fission reactor, or evaporation spectrum neutron source. For example, the energy spectrum of an incident distribution of neutrons may be determined by comparing the measured first neutron flux and the measured at least one additional neutron flux to an expected neutron flux in the first neutron detection element 106 and an expected neutron flux in the at least one additional neutron detection element 106 respectively for a selected set of conditions (e.g., direction of incident neutrons, type of source expected, existence of intervening moderator between source and neutron detection device, size of measurement devices and elements, size of neutron detection system, or type of neutron detection devices used). By way of another example, the type of neutron source or sources may be determined for an incident distribution of neutrons by comparing the measured first neutron flux and the measured at least one additional neutron flux to an expected neutron flux in the first neutron detection element 106 and an expected neutron flux in the at least one additional neutron detecting element 106 for a selected set of conditions.

Additionally, the expected value of the neutron flux at the first detection element 106 and the at least one additional neutron detection element 106 may be established using at least one calibration measurement. For example, as shown in FIGS. 2A through 5D, the expected value of the neutron flux at the first detecting element 106 and the at least one additional neutron detection element 106 may be established by calibrating the neutron detection elements 106 of the neutron detection system 100 using a neutron source wherein the energy spectrum is known (e.g., plutonium source). By way of further example, the expected value of the neutron flux at the first detecting element 106 and the at least one additional neutron detection element 106 may be established by calibrating the neutron detection elements 106 of the neutron detection system 100 using multiple monoenergetic neutron sources.

Further, the expected value of the neutron flux at the first detecting element 106 and the at least one additional neutron detection element 106 may be established using at least one theoretical calculation. For example, as shown in FIGS. 2A through 5D, the expected value of the neutron flux at the first detecting element 106 and the at least one additional neutron detection element 106 may be established by calibrating the neutron detection elements 106 of the neutron detection system 100 using Monte Carlo simulation output data to predict an expected response in the neutron detection elements 106 of a neutron detection system 100.

It should be appreciated by one skilled in the art that the preceding concepts may be extended to all of the neutron detection elements 106 in the neutron detection system 100, including a first detection element 106 and up to and including an Mth detetion element 106. For example, a characteristic of an incident distribution of neutrons may be determined by comparing the measured first neutron detection element flux to the first neutron device element expected flux, the measured second neutron detection element flux to the second neutron detection element expected flux, the measured third neutron detection element flux to the third neutron device element expected flux, and the measured Mth neutron detection element flux to the Mth neutron device element expected flux.

It is further contemplated that the described comparison between the measured detection element fluxes and the expected detection element fluxes may be carried out using a data processing system. For example, a characteristic of an incident distribution of neutrons may be determined by comparing the measured first neutron detection element flux to the first neutron device element expected flux, the measured second neutron detection element flux to the second neutron detection element expected flux, the measured third neutron detection element flux to the third neutron device element expected flux, and the measured Mth neutron detection element flux using a data processing system (e.g., computer programmed system configured for quantifiably comparing measurement flux values to expected flux values).

It is further contemplated that the signal processing described in the preceding description may transmit the determined neutron flux values at the first through Mth detection elements to the data processing system. After comparing the measured flux values of the first through Mth detection elements to the expected flux values of the first through Mth detection elements the data processing system may transmit an electronic signal (e.g., digital or analog signal) to a user output system (e.g., computer controlled system, handheld device, data readout or the like).

In the present disclosure, the methods disclosed may be implemented as sets of instructions or software readable by a device embodied in a tangible media, such as memory. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

Those having skill in the art will recognize that the state-of-the-art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although particular embodiments of this invention have been illustrated, it is apparent that various modifications and embodiments of the invention may be made by those skilled in the art without departing from the scope and spirit of the foregoing disclosure. Accordingly, the scope of the invention should be limited only by the claims appended hereto.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. An apparatus for directional and spectral analysis of neutrons, comprising:
a volume of neutron moderating material; and
a plurality of solid state neutron detection devices disposed within the volume of neutron moderating material, at least some of the neutron detection devices suitable for transduction of primary reaction products resulting from a neutron interaction event,
wherein at least some of the solid state neutron detection elements include two or more solid state neutron detection elements,
wherein the two or more solid state neutron detection elements are configured for omnidirectional detection of impinging neutrons.

2. The apparatus of claim 1, wherein the neutron event comprises:
a neutron capture event, a neutron-induced fission event, or a neutron scattering event.

3. The apparatus of claim 1, wherein the at least some of the neutron detection devices suitable for transduction of primary reaction products comprises:
a neutron detection device suitable for separating electron-hole pairs created by primary reaction products resulting from a neutron interaction event.

4. The apparatus of claim 3, wherein the neutron detection device suitable for separating electron-hole pairs created by primary reaction products resulting from a neutron interaction event comprises:
a solid state heterostructure device.

5. The apparatus of claim 4, wherein the solid state heterostructure device comprises:
a p-n junction diode, a Shottky diode, or a dielectric based heterostructure device.

6. The apparatus of claim 1, wherein the plurality of solid state neutron detection elements are arranged within a detection volume.

7. The apparatus of claim 6, wherein the detection volume is substantially defined by a three dimensional geometric shape.

8. The apparatus of claim 7, wherein the three dimensional shape is a cylinder, a sphere, a cone, a cuboid, an ellipsoid, or a hexagonoid.

9. The apparatus of claim 1, wherein the volume of neutron moderating material is substantially defined by a three dimensional geometric shape.

10. The apparatus of claim 9, wherein at least a portion of the surface of the volume of neutron moderating material is covered with at least one neutron reflector material.

11. The apparatus of claim 1, wherein at least one of the two or more neutron detection elements comprises:
a neutron detecting element having a three dimensional shape.

12. The apparatus of claim 1, wherein the two or more neutron detection elements of at least one of the neutron detecting devices are distributed according to a geometric pattern.

13. The apparatus of claim 1, wherein at least some of the solid state neutron detection devices are substantially planar.

14. The apparatus of claim 1, wherein at least some of the solid state neutron detection elements are linearly positioned along an orientation axis.

15. The apparatus of claim 1, wherein at least some of the solid state neutron detection elements are nonlinearly positioned along an orientation axis.

16. The apparatus of claim 1, wherein at least some of the solid state neutron detection devices are positioned according to a geometric pattern.

17. The apparatus of claim 1, wherein a first solid state neutron detection device of the plurality of solid state neutron detection devices is arranged substantially parallel with respect to at least one additional solid state neutron detection device of the plurality of solid state neutron detection devices.

18. An apparatus for directional and spectral analysis of neutrons, comprising:
a volume of neutron moderating material; and
a plurality of solid state neutron capture devices disposed within the volume of neutron moderating material, at least some of the neutron detection devices suitable for transduction of primary reaction products resulting from a neutron interaction event.

19. A method for neutron directional and spectral analysis, comprising:
measuring a first neutron flux in a first neutron detection element of at least one solid state neutron detection system suitable for omnidirectional detection of neutrons;
measuring at least one additional neutron flux in at least one additional neutron detection element of the at least one solid state neutron detection system suitable for omnidirectional detection of neutrons, the first neutron flux and the at least one additional neutron flux resulting from neutrons emanating from one or more neutron sources; and
determining at least one characteristic of the neutrons emanating from the one or more neutron sources by comparing the measured first neutron flux and the measured at least one additional neutron flux to an expected neutron flux in the first neutron detection element and an expected neutron flux in the at least one additional neutron detection element for a selected set of conditions.

20. The method of claim 19, wherein the measuring a first neutron flux in a first neutron detecting element of at least one solid state neutron detection system suitable for omnidirectional detection of neutrons includes measuring a charge pulse created by a transduction of one or more primary reaction products of a neutron interaction event in the first neutron detection element.

21. The method of claim 19, wherein the measuring at least one additional neutron flux in at least one additional neutron detecting element of the at least one solid state neutron detection system suitable for omnidirectional detection of neutrons includes measuring a charge pulse created by a transduction of one or more primary reaction products of a neutron interaction event in the at least one neutron detection element.

22. The method of claim 19, wherein the determining at least one characteristic of the neutrons emanating from the one or more neutron sources by comparing the measured first neutron flux and the measured at least one additional neutron flux to an expected neutron flux in the first neutron detecting element and an expected neutron flux in the at least one additional neutron detecting element for a selected set of conditions, comprises:
determining at least one characteristic of the neutrons emanating from the one or more neutron sources by comparing the measured first neutron flux and the measured at least one additional neutron flux to a theoretically predicted neutron flux in the first neutron detecting element and a theoretically predicted neutron flux in the at least one additional neutron detecting element for a selected set of conditions.

23. The method of claim 19, wherein the determining at least one characteristic of the neutrons emanating from the one or more neutron sources by comparing the measured first neutron flux and the measured at least one additional neutron flux to an expected neutron flux in the first neutron detecting element and an expected neutron flux in the at least one additional neutron detecting element for a selected set of conditions, comprises:
determining at least one characteristic of the neutrons emanating from the one or more neutron sources by comparing the measured first neutron flux and the measured at least one additional neutron flux to an expected neutron flux in the first neutron detecting region and an expected neutron flux in the at least one additional neutron detecting element for a selected set of conditions, the expected neutron flux in the first neutron detecting element and the expected neutron flux in the at least one additional neutron detecting element established by at least one previous calibration measurement.

24. The method of claim 19, wherein the at least one characteristic of the neutrons emanating from the one or more neutron sources is neutron energy, neutron energy spectrum, spatial point of emanation of a portion of the neutrons, or source of the neutrons.

25. The method of claim 19, wherein the one or more neutron sources may comprise:
a thermal neutron source, a fast neutron source, a thermal and fast neutron source, a moderated fast neutron source, a spontaneous fission source, cosmic-ray induced spallation, a fission reactor, or evaporation spectrum neutron source.
